(19) United States
(12) Patent Application Publication
(10) Pub. No.: US 2025/0392172 A1
(43) Pub. Date: Dec. 25, 2025

(54) STATOR FOR AN ELECTRIC MOTOR OR A GENERATOR, IN PARTICULAR FOR AN EXTERNAL ROTOR MOTOR

(71) Applicant: ZIEHL-ABEGG SE, Künzelsau (DE)

(72) Inventor: Joachim SCHMEZER, Niedernhall (DE)

(73) Assignee: ZIEHL-ABEGG SE, Künzelsau (DE)

(21) Appl. No.: 18/878,937

(22) PCT Filed: Jun. 23, 2023
(86) PCT No.: PCT/EP2023/000037

§ 371 Date: Mar. 27, 2025

(30) Foreign Application Priority Data
Jun. 27, 2022 (DE) 10 2022 002 346.6

(51) Int. Cl. H02K 1/14; H02K 3/52

(52) U.S. Cl. CPC H02K 1/146; H02K 3/522; H02K 2203/12

(57) ABSTRACT

A stator of an electric machine has a ring region from which teeth protrude. Each tooth has an arm that extends from the ring region, has a web running transversely to the arm at the free end and supports at least one winding. The winding has at least one coil wound by a winding wire and is accommodated in a winding space which extends from the ring region. The winding space is divided by at least one separating web into successive winding sections which are provided on the arm. Using the separating web, the respective winding space section can be adapted to the wire diameter and to the number of turns in such a way that the start of the wire and the end of the wire can be provided in the radially inner ring region of the stator.

### CROSS-REFERENCE TO RELATED APPLICATION

This application is a national stage application, filed under 35 U.S.C. § 371, of International Patent Application PCT/EP2023/000037, filed on Jun. 23, 2023, which claims the benefit of German Patent Application DE 10 2022 002 346.6, filed on Jun. 27, 2022.

### TECHNICAL FIELD

The disclosure relates to a stator for an electric motor or a generator, in particular for an external rotor motor.

### BACKGROUND

The winding of the stator is frequently created by means of a so-called orthocyclic winding process. For this purpose, the first layer of the coil is wound in such a way that each turn crosses the axis line orthogonally, i.e. at right angles, for most of its circumference. The problem with orthocyclic windings used to date, in particular with contiguously wound adjacent teeth and with coils wound on top of one another (e.g. for parallel connection of the coils), is that the start of the wire and the end of the wire are meant to be in the region of the inner diameter in the case of external rotor motors for the purpose of making contact. This is, however, not possible for all the desired combinations of wire diameters and number of turns, since, for example, the last turn is in the region of the tooth centre and the winding direction runs from radially inside to outside in the most unfavourable case. If, in this case, the winding wire is to be directly led radially inwards, this leads to the winding wire being pulled back, so that loose wires can be created. These can lead to problems during further winding or later in the use of the stator.

A further problem is the lack of space in the radially inner region for the wires or the winding needle required for winding. The intermediate space between adjacent teeth of the stator tapers radially inward, so that there is less space for the winding wire in the radially inner ring region than in the radially outer region.

If the winding wire is to be led further from one tooth to another tooth, the last turn of the winding wire has to be in the radially inner ring region, in order to be able to be wound, after the wire transition to the adjacent tooth, around said tooth.

In order to influence the position of the wire end, it is known to lay the start of the winding wire at a more favourable position via a slot in the end face of an insulation element, such as an insulating washer. However, if the number of turns is too high, a new layer has to be started in the winding process, meaning that there is insufficient space for the turns or the winding needle when a coil is wound over a first coil.

### SUMMARY

The disclosure improves a generic stator such that a simple and reliable winding process can be realised.

In the stator according to the disclosure, the winding space is divided by the at least one separating web into successive winding space sections, which are provided on the arm of the tooth. Using the separating web, the respective winding space section can be adapted to the wire diameter and to the number of turns in such a way that the start of the wire and the end of the wire can be provided in the radially inner ring region of the stator. As a result of the design according to the disclosure, it is also possible to provide the transition of the winding wire from the one tooth to the other tooth in the radially inner ring region. The separating web can provide that a suitable distribution of the turns is achieved in such a way, depending on the diameter of the winding wire and the number of turns, that the end of the wire and the start of the wire are in the ring region, and the wire transition from one to the other tooth can take place in this region.

The separating webs are advantageously provided on the upper side and the underside of the teeth of the stator. Therefore, a flawless winding process of the teeth of the stator is guaranteed.

In one advantageous embodiment, the separating webs are arranged in such a way that the winding space sections are of different lengths. The radially outer winding space section can be shorter in the radial direction of the teeth than the radially inner winding space section. Since the distance between adjacent teeth is greater in the region of the radially outer winding space section than in the region of the radially inner winding space section, the radially outer winding space section can be filled primarily with the winding wire, so that the space in the radially inner winding space section can be used for the start of the wire and the end of the wire or for the transition to the next tooth.

In one advantageous embodiment, the separating webs of at least some of the teeth have a passage for the winding wire on the upper side or underside. During the winding process, the winding wire can be guided in a simple manner from the one into the other winding space section through this passage.

In a preferred embodiment, the guides run at an angle diagonally to the longitudinal direction of the teeth. The winding wire accordingly runs correspondingly diagonally as it passes through this passage. The so-called laying angle is to be advantageously as small as possible, so that the winding wire does not collide with a linking body radially delimiting the one winding space section or with the tooth in the region of this passage.

The separating web is preferably positioned on the tooth such that the end of the coil or the winding wire is on the ring region.

In order to ensure flawless winding, in an advantageous development, the radially inner winding space section has such a width in the circumferential direction of the stator that the number of layers of the coil in this winding space section is even.

Advantageously, the radially outer winding space section has such a width in the circumferential direction of the stator that the number of layers of the coil in this winding space section is a multiple of the layers in the radially inner winding space section. Therefore, it is possible in a simpler and reliable manner to guide the winding wire laterally over the separating webs when creating further layers, without the winding being adversely influenced.

Preferably, the thickness of the separating web having the passage, measure at the base of the separating web, is an integer multiple of the diameter of the winding wire. When winding a second coil, in particular by orthocyclic winding, such a design advantageously means that the winding wire can be wound over the separating web.

When at least one linking body for deflecting the winding wire is provided on the free end of the arms of the teeth, this helps to easily guide of the winding wire.

Advantageously, the linking body radially delimits the radially outer winding space section.

In order for the winding wire to be flawlessly guided during the winding process in the region of the linking body and/or of a deflecting body, they are provided with at least one axial securing element. It prevents the winding wire slipping off axially from the linking body and/or from the deflecting body during the winding process.

A reliable and flawless securing is achieved in an advantageous manner if the axial securing element protrudes transversely from the linking body and/or from the deflecting element.

In an advantageous manner, the separating web is a part of an insulation element lying on the end faces of the teeth, which consists of an electrically non-conductive material.

Advantageously, the insulation element is an insulating washer which is arranged on the end faces of the teeth of the stator.

Instead of the insulating washer, it is also possible to provide the separating webs as a part of an overmoulding of a stator stack.

The invention is explained in more detail using two exemplary embodiments represented in the drawings.

### BRIEF DESCRIPTION OF THE DRAWINGS

FIG. 1 shows a perspective representation of a switching side of a stator in the unwound state,

FIG. 2 shows a perspective representation of an underside of a stator according to FIG. 1,

FIG. 3 shows a perspective and enlarged representation of a part of the switching side of the stator without winding,

FIG. 4 shows a perspective and enlarged representation of a part of the switching side of the stator in another view,

FIG. 5 shows a plan view and enlarged representation of a part of the switching side of the stator with winding wires of a first coil.

FIG. 6 shows a perspective and enlarged representation of a part of the underside of the stator showing the starts and ends of the first coil,

FIG. 7 shows a representation according to FIG. 5 of the winding process of the stator with the first coil on the switching side,

FIG. 8 shows a representation according to FIG. 7 of the winding of a second coil,

FIG. 9 shows a perspective representation of the wire laying of a second coil on the underside of the stator,

FIG. 10 shows the winding of the second coil on the switching side of the stator,

FIG. 11 shows the wire laying on the switching side of the stator,

FIG. 12 shows a perspective representation of an insulating washer provided for a switching side of the stator,

FIG. 13 shows a perspective representation of an insulating washer provided for the underside of the stator.

### DETAILED DESCRIPTION

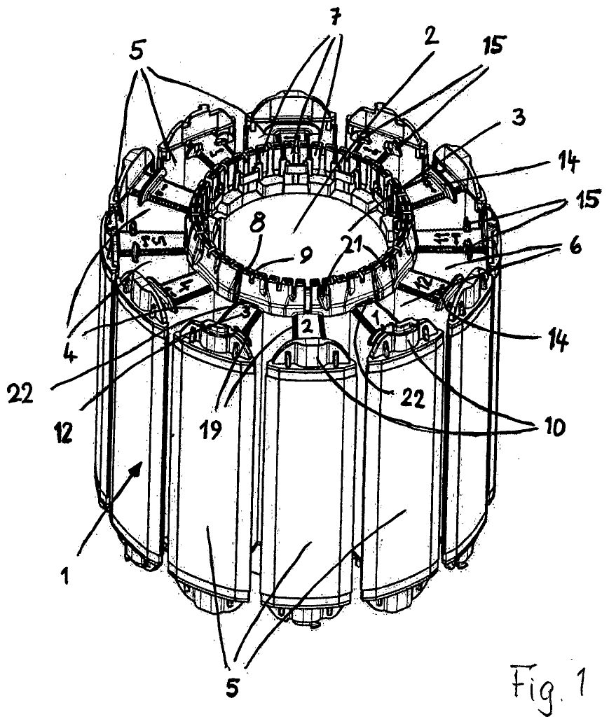

FIG. 1 shows a stator which can be a part of an electric motor or a generator. The stator has a stator stack 1, which consists in a known manner of stacked laminations which are fixedly connected to each other, for example by an adhesive connection, a weld connection, a positive-locking connection or the like. The stator stack 1 has a central circular through-opening 2.

The stator stack 1 has a cylindrical inner ring 3 from which radial arms 4 protrude. They are arranged distributed evenly over the circumference of the stator stack 1 and are each provided with a web 5 extending in the circumferential direction on the free radially outer end. As shown in FIG. 1, the webs 5 and the arms 4 extend over the height of the stator stack 1. The webs 5 advantageously project the same distance beyond both sides of the arm 4 in the circumferential direction.

The arms 4 and the webs 5 are distanced from each other in the circumferential direction of the stator.

The arms 4 and the webs 5 each form teeth 1 to 12 of the stator, which are wound with winding wire in a manner still to be described.

Adjacent arms 4 delimit grooves 6 through which the winding of the stator 1 runs in a manner still to be described.

Receiving pockets 7 for insulation displacement contacts for contacting the winding wire axially protrude from the end face of the inner ring 3 visible in FIG. 1.

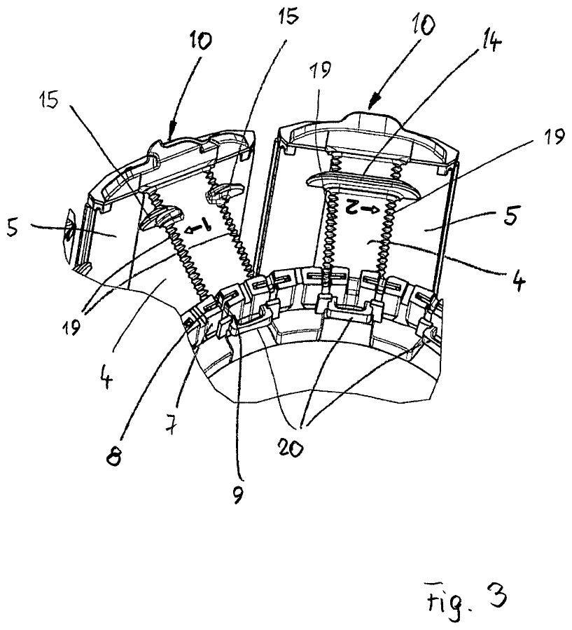

The receiving pockets 7 advantageously lie in the circumferential direction at a distance from each other. The receiving pockets 7 each have a slot-shaped inclusion 8 (FIG. 3) extending in the circumferential direction, into which the insulation displacement contact is plugged. The inclusion 8 is advantageously crossed at half its length by a transverse slot 9 which extends only over a part of the height of the receiving pocket 7 and through which the winding wire runs in a manner still to be described. The inclusion 8 and the transverse slot 9 are open towards the free end face of the receiving pockets 7. Therefore, the insulation displacement contacts can be plugged axially into the inclusions 8, where they contact the winding wire running in the radial direction of the stator stack 1 in a known manner.

The side on which the receiving pockets 7 are located is referred to as a switching side of the stator in the following, because the contacting of the winding wires takes place on this end face.

Linking bodies 10 which serve to delimit the winding space and for supporting the winding on the stator protrude radially from the webs 5 on both end faces. The linking bodies 10 can serve to guide the winding wire during the wire deflecting when needed.

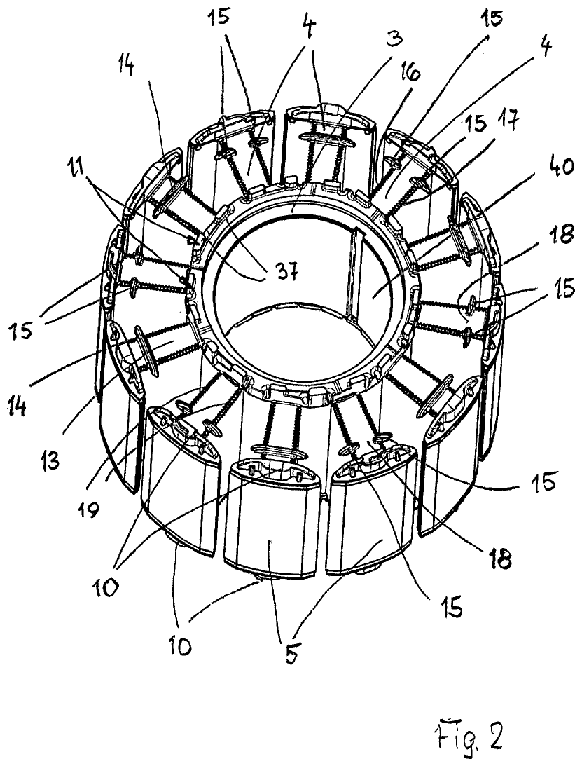

The linking bodies 10 are designed substantially all the same and extend in the circumferential direction almost over the circumferential width of the webs 5 (FIGS. 1 and 2).

Insulating washers 12, 13 are provided on both end faces of the stator (FIG. 1, 2, 12, 13) which form ring spaces which are delimited radially outward by the linking bodies 10. On the switching side (FIG. 1), the ring space is delimited radially inward by the receiving pockets 7. On the underside (FIG. 2), the ring space is delimited radially inward by guide bodies 11 which lie next to each other at a distance over the circumference of the inner ring 3 and protrude axially from the inner ring 3.

The insulating washers 12, 13 insulate the stator stack 1 electrically from the winding. The insulating washers 12, 13 are designed in a known manner such that they cover the end faces of the arms 4 of the stator stack 1, parts of the inner ring 3 and the webs 5. The insulating washers 12, 13 thus form parts of the arms 4 of the stator.

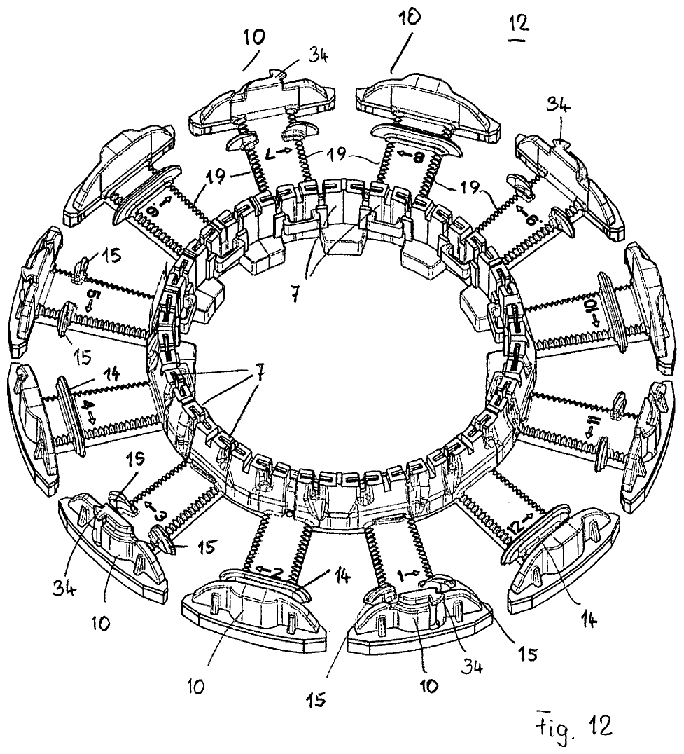

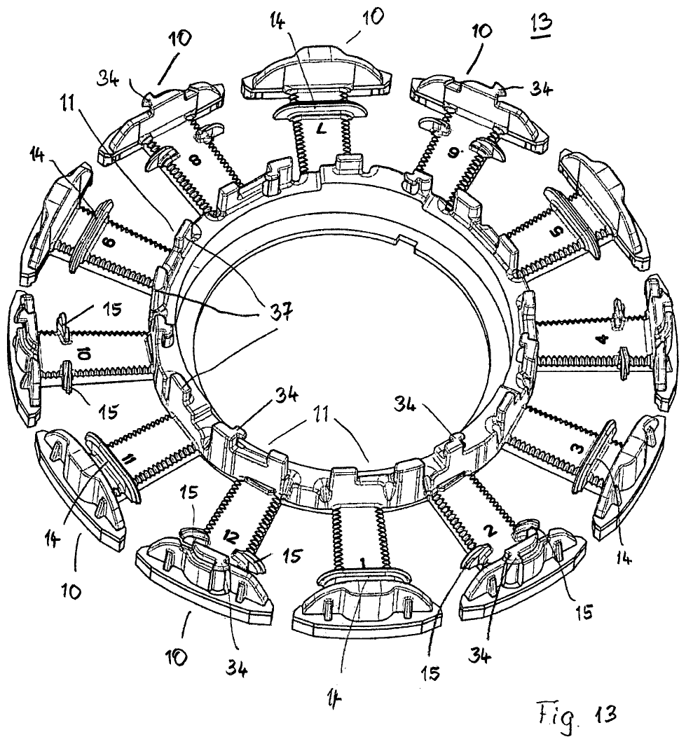

The insulating washers 12, 13 represented in FIGS. 12 and 13 differ slightly from the insulating washers 12, 13 represented in FIGS. 1 to 11 with regard to details. The differences are, however, so minor that they are not discussed in more detail.

Webs 14, 15 which protrude axially from the insulating washers 12, 13 are located on the end-faces insulating washers 12, 13. The webs 14 extend over the entire circumferential width of the arms 4, 2, while the webs 15 are provided in the region of the radially running longitudinal sides 16, 17 of the arms 4 and have a distance from each other in the circumferential direction. Passages 18 are formed between the webs 15 (FIG. 2).

The guide bodies 11 located on the underside of the stator stack 1 are formed by deflecting journals which axially protrude from the inner ring 3 and are used for the wire laying of a connecting wire between adjacent arms 4.

The webs 14, 15 and the guide bodies 11 are a part of the insulating washers 12, 13 which are attached in a known manner to both end faces of the stator stack 1.

As is shown in FIGS. 1 and 2, the webs 14, 15 are arranged alternately on the individual arms 4, in order to form separate winding sections. The webs 14, 15 have a radial distance from the linking bodies 10 and the receiving pockets 7 or the guide bodies 11 (FIGS. 1 and 2). The webs 14, 15 in this case have a smaller distance from the linking bodies 10 than from the receiving pockets 7 or the guide bodies 11.

The webs 14, 15 are advantageously at the same height in the circumferential direction of the stator stack 1.

In FIG. 1, the teeth are numbered with 1 to 12. In this example, the stator stack 1 has twelve teeth 1 to 12 which are each designed identically. Depending on the size/or diameter of the stator, the stator stack 1 can have a larger or smaller number of teeth.

The arms 4 of the teeth are each provided with a grooving 19 on their longitudinal sides 16, 17 at the transition to their end faces (FIG. 3), which grooving extends over the entire radial length of the arms 4. As is shown in FIGS. 1 and 2, each arm 4 is advantageously provided with such a grooving 19 on its two longitudinal sides at the transition to its end faces. The groovings 19 are provided on the two insulating washers 12, 13, as is evident from FIGS. 12 and 13.

The groovings 19 serve to guide the winding wires cleanly, in order to enable an orthocyclic guidance in a manner still to be described.

The winding wire is deflected at the linking bodies 10 in a manner still to be described for a 4-group parallel circuit, in order to be able to guide the wire end of the second coil from the outside to the inside into the receiving pockets 7.

As shown in FIG. 3, the receiving pockets 7 are provided with brackets 20 on their rear side facing away from the linking bodies 10. These brackets are designed such that they connect adjacent receiving pockets 7 to each other. The brackets 20 are only optionally provided. They are joined to the receiving pockets 7 in such a way that they do not project into the transverse slots 9 of the receiving pockets 7, so that the winding wires can be guided unhindered through the transverse slots 9.

The design and procedure for winding the stator stack 1 described in the following is explained using the teeth 1 and 2. The remaining teeth 3 to 12 of the stator stack 1 are also wound in an identical manner.

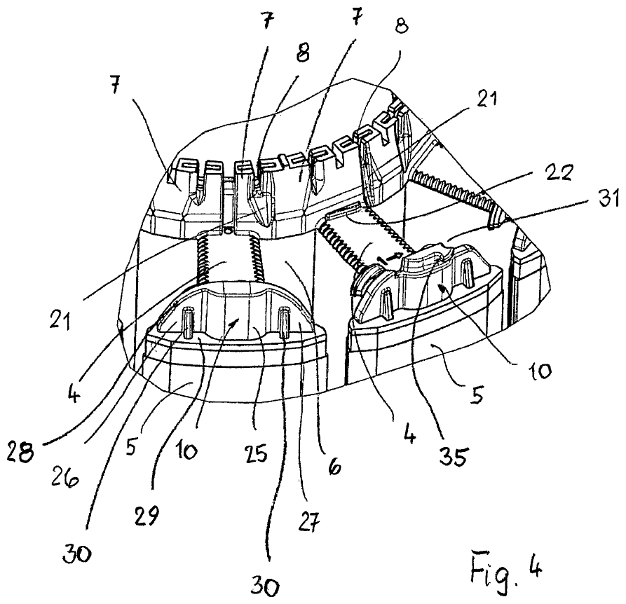

As shown in FIG. 4, insertion slots 21 for the winding wire are located in the region of the receiving pockets 7. They are provided on the side facing towards the linking bodies 10 and are arranged distributed over the circumference of the stator stack 1. The insertion slots 21 are at the same height as the transverse slots 8 of the corresponding receiving pockets 7 (FIGS. 1 and 4).

The insertion slots 21 taper axially from the transverse slots 8 and are in the region of grooves 6 between adjacent teeth. The insertions slots 21 have the effect that the winding wire does not hinder further winding with the winding needle.

As FIG. 4 shows, a guide piece 22 which has a triangular outline in the axial direction of the stator stack 1 is provided at the base of the one contact pocket 7. The guide piece 22 lies on the end face of the arm 4 of the tooth 1 and has an advantageously constant axial height over its length measured in the circumferential direction. The triangular guide piece 22 serves to guide the first winding wire in order to be able to install this orthocyclically.

Alongside the circumference of the stator stack 1, further such triangular guide pieces 22 are provided, as shown in FIG. 1. In the exemplary embodiment, such guide pieces 22 are located on the teeth 1, 3, 5, 7, 9 and 11 of the switching side and on the teeth 2, 4, 6, 8, 10 and 12 on the underside of the stator stack 1.

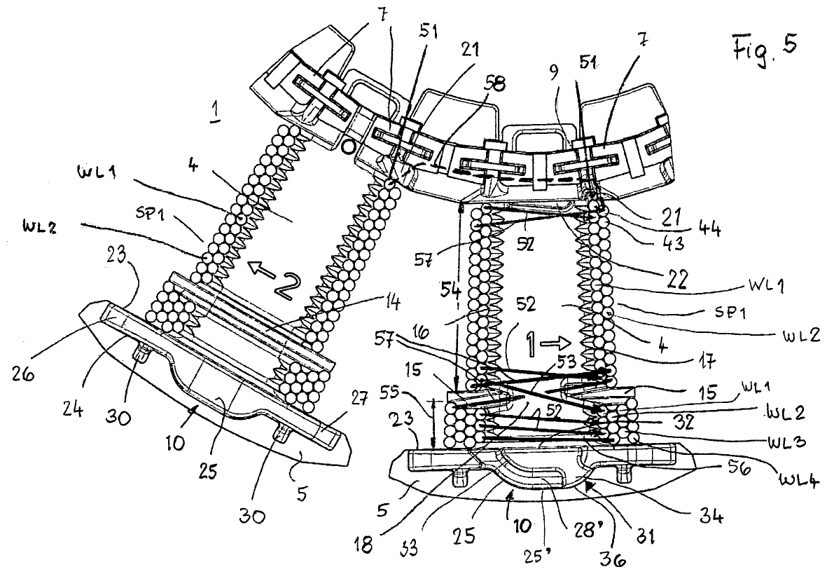

The linking bodies 10 extend in the circumferential direction of the stator stack 1 almost over the corresponding circumferential length of the webs 5 of the teeth 1 to 12. As shown in FIGS. 1 and 2, the linking bodies 10 are provided in two structural designs. This is explained in more detail using FIGS. 4 and 5.

The winding body 10 of the tooth 2 has a level end face 23 facing towards the receiving pockets 7, which extends in the axial direction of the stator stack from the web 5 of the tooth and advantageously runs perpendicular to the end face of the web 5 of the tooth 2.

For half of its circumferential length, the linking body 10 is designed to be thicker by providing the rear side 24 facing away from the receiving pockets 7 with a protuberance. Therefore, the linking body 10 has a centre part 25 thickened in the radial direction. It has the same axial height over its circumferential length (FIG. 4) and advantageously transitions curved into the rear side 24.

The side parts 26, 27 projecting in the circumferential direction beyond the centre part 25 (FIG. 4) decrease steadily in axial height outwardly in such a way that the end face 28 of the linking body 10 adjoins the end face 29 of the tooth web 5 at an angle.

The thin side parts 26, 27 are reinforced on the rear side 24, in each case by a rib 30 protruding transversely from the end face 29 of the web 5. The rib is advantageously designed in one-piece with the linking body 10 and the insulating washer 12. Advantageously, the ribs 30 are located approximately at half of the width of the side parts 26, 27. The ribs 30 are designed so that they do not project axially beyond the side parts 26, 27 of the linking body 10, but advantageously have an axial distance from the end face 28 of the linking body 10.

The described development of the linking body 10 is provided on the teeth 2, 4, 6 of the stator stack 1 (FIG. 1).

The linking bodies 10 facing towards the other teeth 1, 3, 5 have a similar construction to the above-described linking bodies 10. The difference is substantially that a deflecting element 31 is provided on the end face 28′ of the centre part 25. The deflecting element has fundamentally the same outline shape as the centre part 25, however it is narrower in the radial direction than the centre part 25. The end face 32 of the deflecting element 31 facing towards the receiving pockets 7 lies in a plane with the end face 23 of the linking body 10 (FIG. 5).

Opposite to the rear side 25′ of the centre part 25, the rear side 33 of the deflecting element 31 is radially recessed. A lug 34 which has an axial distance from the end face 28′ of the centre part 25 projects from the rear side 33. Therefore, at this point a passage 35 (FIG. 4) is formed for the winding wire.

The free end face 36 of the lug 34 lies in the rear side 25′ of the centre part 25, as viewed in the axial direction (FIG. 5).

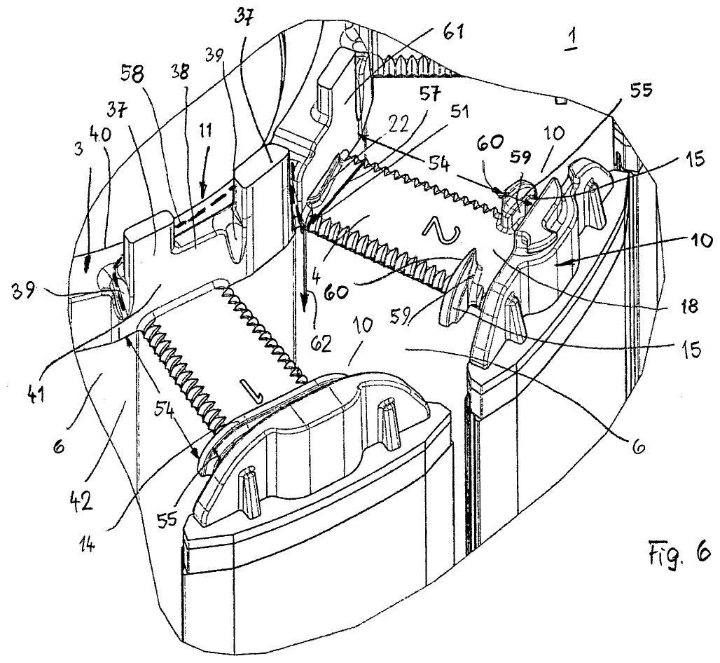

As shown in FIG. 6, the linking bodies 10 are designed in an identical manner on the underside of the stator stack 1. The arrangement of the differently designed winding bodies is different to on the switching side, however.

As a comparison of FIGS. 5 and 6 shows, the tooth 1 has the linking body 10 with the deflecting element 31 on the switching side (FIG. 5). On the underside, the tooth 1 is arranged with the linking body 10 without the deflecting element 31. Therefore, the tooth 2 with the linking body 10 having the deflecting element 31 is provided on the underside, while the tooth 2 has the linking body 10 without the deflecting element on the switching side (FIG. 5).

Both on the switching side (FIG. 5) as well as on the underside (FIG. 6), the differently designed linking bodies 10 alternate in the circumferential direction, respectively. This design on the switching and on the underside of the stator is evident in particular from FIGS. 12 and 13. On the switching side (FIG. 12), the teeth 2, 4, 6, . . . are provided with the separating webs 14, which are provided on the underside (FIG. 13) on the teeth 1, 3, 5, . . . . Correspondingly, the separating webs 15 are provided on the switching side (FIG. 12) on the teeth 1, 3, 5, . . . and on the underside (FIG. 13) on the teeth 2, 4, 6, . . .

The deflecting elements 31 are advantageously designed as one-piece with the linking body 10, which is moreover designed identical to the linking body 10 without the deflecting element 31.

The linking body 10 having the lugs 34 forms hooks, which prevent the winding wire from sliding out upwards at a deflection of the winding wire when the end of the wire is guided inwards into the corresponding receiving pockets 7.

The linking bodies 10 on the underside of the stator stack 1 lie opposite the guide bodies 11, which are explained in more detail using FIG. 6.

The guide body 11 has two deflecting journals 37 protruding axially from the inner ring 3, which are at a distance from each other in the circumferential direction and are connected to each other by a web 38. It has a lower axial height than the two deflecting journals 37. The web 38 is provided with an end-face recess 39 adjacent to the one deflecting journal 37. The recess is level with the corresponding groove 6 between the adjacent teeth 1, 2.

A further recess 39 is located on the outer side of the one deflecting journal 37 which is level with the next groove 6. The two recesses 39 are thus level with adjacent grooves 6.

The one deflecting journal 37 is located at the height of the tooth 1, while the adjacent deflecting journal 37 of the guide body 11 is provided in the region of the groove 6 between the two teeth 1, 2.

As shown in FIG. 2, the guide bodies 11 are arranged successively at a distance in the circumferential direction and are in each case provided with the two deflecting journals 37.

The guide bodies 11 are spaced apart from the inner wall 40 of the inner ring 3, as viewed in the axial direction. The front side 41 facing towards the linking bodies 10 (FIG. 6) is advantageously flush with the outer side 42 of the inner ring 3.

The guide bodies 11 can also be provided with the lugs 34 (FIG. 13), with which similarly axial slippage of the winding wire is prevented.

The lugs 34 of the linking bodies 10 and of the guide bodies 11 are arranged alternately diagonally to the circumferential direction of the stator, as is shown in particular in FIGS. 12 and 13.

In FIG. 5, the circles represent the winding wires 43 of the first coil SP1 in the cross-section. The arrows mark the winding direction on the switching side of the stator stack. The winding wire is inserted through the transverse slot 9 of the one receiving pocket 7 radially from inside at the height of the tooth 1. The start point of the winding process is labelled with 51.

On the switching side (FIG. 5) of the stator stack 1, the winding wire 43 is guided diagonally in relation to the radially running longitudinal axis of the arm 4 of the tooth 1 along the triangular guide piece 22. This is marked by the arrow 52 in FIG. 5.

The winding wire 43 is guided out from the switching side along the respective longitudinal side 16, 17 downwards to the underside of the tooth 1. Since, on the underside of the tooth 1, a triangular guide piece is not present, the winding wire 43 runs perpendicular to the radial longitudinal axis of the arm 4 of the tooth 1 on the underside of the stator stack.

By means of the groovings 19, which are provided both on the switching side as well as on the underside of the stator stack, flawless winding of the winding wire 43 is ensured, which engages with the first winding layer WL1 in the grooving 19.

Once the winding wire 43 comes into the region of the webs 15 on the switching side, the winding wire 43 is guided through the passage 18 between the two webs 15 (arrow 53).

In this manner, the winding wire 43 comes from a winding space 54 into a winding space 55. The winding space 54 is located between the contact pockets 7 and the webs 15 and is advantageously longer in the radial direction of the tooth 1 than the winding space 55 between the webs 15 and the end face 23 of the linking body 10.

Since the grooving 19 is provided in both winding spaces 54, 55, flawless winding is ensured in the two winding spaces 54, 55.

When transitioning from the winding space 54 through the passage 18 to the winding space 55, the winding wire 43 on the switching side runs at a greater angle to the radial longitudinal axis of the arm 4. The course of the winding wire as it passes through the passage 18 is marked with 53.

Since the transition from the winding space 54 into the winding space 55 takes place on the switching side of the stator stack in the described manner, an interrupted web design is not required on the underside of the stator stack 1 in the region of the tooth 1. Correspondingly, the continuous web 14 (FIG. 6) is provided on the tooth 1 on the underside instead of the two webs 15.

Inside the winding space 55, the winding process takes place in the winding direction 52 until the first layer of the winding is formed in the winding space 55. The formation of the next layers in the winding space 55 begins with the next winding process (arrow 56). In the exemplary embodiment, four layers WL1 to WL4 are formed in the winding space 55.

The two webs 15 on the switching side of the stator stack 1 are so wide in the circumferential direction that the four layers WL1 to WL4 of the first coil SP1 are secured in the radial direction in the winding space 55. The winding layers are also secured by the web 14 radially on the underside by the web 14 on the underside of the stator stack 1 (FIG. 6).

The winding wire in the last layer WL4 of the winding space 55 is again returned through the passage 18 between the two webs 15 on the switching side of the stator stack 1 radially from the outside radially inwards. The winding direction 57 in turn runs diagonal to the radial longitudinal direction of the arm 4 of the tooth 1. The winding direction 57 in this case is opposed diagonally to the winding direction 52. In this winding phase, the winding takes place radially from the outside radially inwards. By way of example, the second layer WL2 is formed in the winding space 54 after the winding wire has passed through the passage 18. As soon as the second layer WL2 of the coil SP1 has been created in the region of the receiving pocket 7 in the winding space 54, the winding wire is guided on the underside of the stator stack 1 to the tooth 2. This is marked by the dashed line 58. The tooth 2 is then wound in an identical manner to tooth 1. The starting point 51 on the tooth 2 corresponds to the starting point 51 on the tooth 1, however the starting point 51 on the tooth 2 is not located on the switching side, but rather on the underside.

The webs 15 are designed in an advantageous manner such that the winding wire can be guided laterally at the webs 15 when passing through the passage 18. For this, the webs 15 are provided at their two outer sides with correspondingly diagonally running guide surfaces 59, 60 (FIG. 6), on which the winding wire 43 can be guided when passing through the passage 18.

The end of the coil SP1 on the tooth 1 is guided to the underside of the stator stack 1 in the described manner, and there is guided by means of the deflecting journals 37 to the tooth 2. As results from FIG. 6, the winding wire 43 is guided on the rear side facing away from the linking body 10 to the tooth 2. Then the winding process of the tooth 2 takes place at the starting point 51 to form the first coil SP1.

The windings are not represented for the sake of clarity, as in the case of FIG. 5.

Starting from the starting point 51, the winding wire 43 is guided along the triangular guide piece 22 diagonally to the radial longitudinal direction of the arm 4 of the tooth 2 on the underside of the stator stack 1. The guide piece 22 is provided in this case on the front side 61 of the guide body 11 facing towards the linking body 10. Advantageously, the guide piece 22 is designed as one piece with the guide body 11. The guide piece 22 lies on the upper side of the arm 4, so that the winding wire can be reliably guided on the underside of the stator pack 1.

On the underside of the tooth 2, provided adjacent to the linking body 10 are the two webs 15, which separate the two winding spaces 54, 55 from each other. In this case, the winding space 54 is provided between the guide body 11 and the webs 15 and the winding space 55 is provided between the webs 15 and the linking body 10.

The winding process of the tooth 2 takes place in an identical manner to tooth 1. The winding direction is diagonal to the radial longitudinal direction of the arm 4 of the tooth 2, as described. The winding space 54 between the two webs 15 and the guide body 11 or the winding space 55 between the webs 55 and the linking body 10 is filled by the wire layers WL1, WL2 in the described manner. The winding wire 43 is guided through the passage 18 between the two webs 15 during the winding process. The last winding of the winding wire 43 is marked by the arrows 57, 62, the end of which winding wire is again guided back to the switching side (FIG. 5) through the corresponding receiving pocket 7.

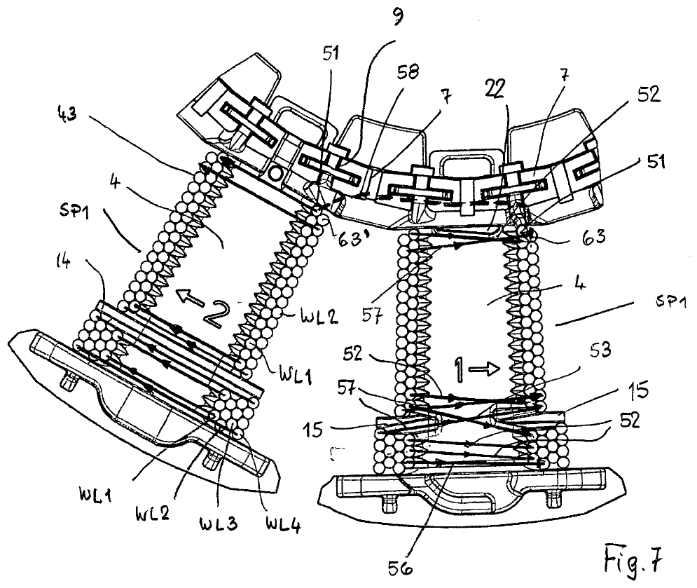

FIG. 7 shows the winding process for creating the first coil SP1 using the two teeth 1 and 2. The winding direction for tooth 2 is the opposite to that for tooth 1, which is marked by the drawn arrows. The tooth 2 is provided with the continuous web 14 on its switching side, while it has the two webs 15 on the underside (not shown), as shown in FIG. 6. In the case of the tooth 1, in comparison, the continuous web is located on the underside, while the two webs 15 with the passage 18 are provided on the shown switching side.

As has been explained using FIG. 5, the continuous web 14 serves to provide the turns of the wire parallel to each other, perpendicular to the radial longitudinal direction of the arm 4. By contrast, the webs 15 ensure that the turns run diagonal to the radial longitudinal direction of the arm 4.

The winding process takes place from the radially inner region of the arms 4 radially outwards on both teeth 1, 2. Subsequently, the winding process takes place radially from the outside radially inwards. The end point 63 of the winding process on the tooth 1 is located immediately adjacent to the respective receiving pocket 7. The wire is guided in the described manner from the end point 63 to the underside of the tooth 1 along the track 58 to the starting point 51 on the underside of the tooth 2. The winding of the tooth 2 takes place analogous to the winding of the tooth 1.

At the end point 63′ of the first coil SP1 of the tooth 2, the winding wire 43 is guided radially inwards through the transverse slot 9 of the receiving pocket 7.

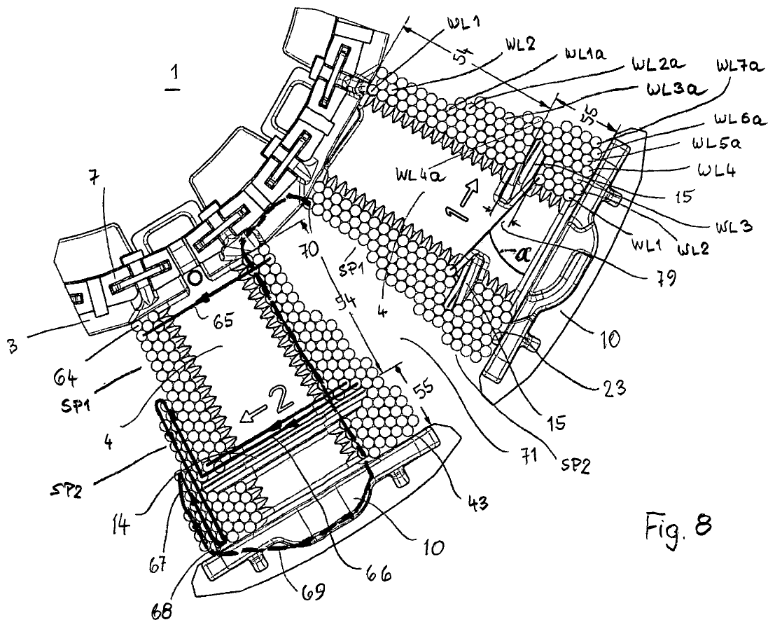

It is described using FIGS. 8 to 11, how a second coil SP2 is attached in a winding process to the teeth 1 and 2. The first coil SP1 has been wound onto the teeth 1, 2 in the described manner. The process of winding the second coil SP2 onto the tooth 2 starts in the receiving pocket 7 on the switching side of the stator stack 1 (FIG. 8). The winding process for creating the second coil SP2 begins at the starting point 64 adjacent to the receiving pocket 7. The winding of the winding wire 43 takes place perpendicular to the longitudinal axis of the arm 4 of the tooth 2. The winding direction is marked with 65.

The winding process is carried out up to the continuous web 14 on the switching side of the stator stack 1. In the last winding 66 before the web 14, to create the second coil SP2 the winding wire is moved back and forth from the web 14 in the longitudinal direction of the arm 4, as is specified by the movement path 67. The desired number of layers WL1a to WL7a is applied onto the first coil SP1 by this meandering winding back and forth. As a result, the layers WL1a to WL7a of the second coil SP2 are created up to the linking body 10.

In the exemplary embodiment, the second coil SP2 is wound such that it extends in the winding space 54 over a part of the radial length, whereas it is provided in the winding space 55 over the entire radial width thereof. At the end point 68 on the linking body 10, the second coil SP2 of the tooth 2 is finished. The winding wire is then guided along the track 69 on the underside of the tooth 2 to the starting point 70 on the underside of the tooth 1. Then, the second coil SP2 of the tooth 1 is wound on the tooth 1, analogous to tooth 2.

The winding space 54, 55, and thus the number of possible turns on the teeth 1, 2, is delimited by the free space 71 for the winding needle between the two teeth 1, 2. This can have the result that the second coil SP2 may not end radially inside on the arm 4, but that the winding wire on the outside has to be returned inwards via the linking body 10. This case is shown in FIG. 8. The wire 43 is deflected along the track 69 on the underside of the tooth 2 on the radially outer outer side of the lower winding body in such a way that it can be subsequently guided on the underside radially inwards in the direction of the inner ring 3 and therefrom to the tooth 1.

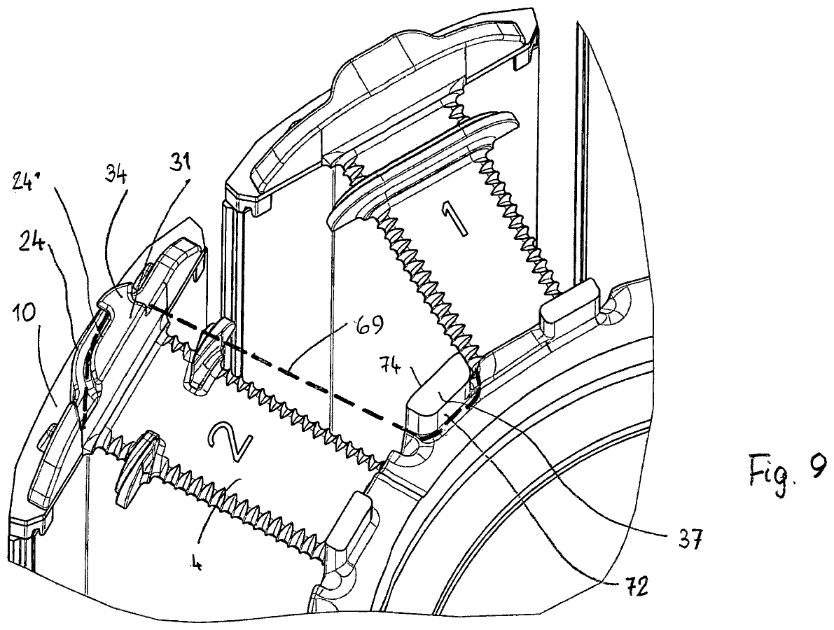

FIG. 9 shows this transition to the underside of the teeth 1, 2 from the tooth 2 to the tooth 1. The wire 43 is initially guided on the rear side 24 of the linking body 10 facing away from the deflecting journals 37 in the described manner. The linking body has the deflecting element 31 having the lug 34. In order to ensure a clean deflection of the wire 43, the rear side 24′ of the deflecting element 31 facing away from the deflecting journal 37 is curved, so that the wire 43 can be deflected radially inwards to the opposite deflecting journal 37 without risk of buckling. The lug 34 of the deflecting element 31 prevents the wire 43 from lifting off axially from the linking body 10 or its deflecting element 38 in this region.

Similarly, a projecting lug which prevents the wire 43 from axially slipping out can be provided analogously to the deflecting element 31 on the deflecting journal 37.

The wire 43 is deflected at the rear side 72 of the deflecting journal 37 facing away from the linking body 10. Advantageously, the rear side 72 can be provided with a recess for receiving the wire. The recess extends in the circumferential direction of the deflecting journal 37. The rear side 72 and, if present, the recess in each case transition steadily curved into the front side 74 of the deflecting journal 37 facing towards the linking body 10.

The recess can be provided in addition to or instead of a projecting lug on the deflecting journal 37, in order to prevent the winding wire 43 from slipping out axially.

The transition during the winding process takes place from the tooth 2 to the tooth 1 on its underside by the described deflection by means of the deflecting element 31 and the deflecting journal 37.

As has been described using FIGS. 8 and 9, the end of the coil SP2 is on the tooth 2 on the radially outer end of the arm 4. By means of the linking body 10, the wire is guided radially inward to the deflecting journal 37, via which the wire is guided on the underside to the tooth 1.

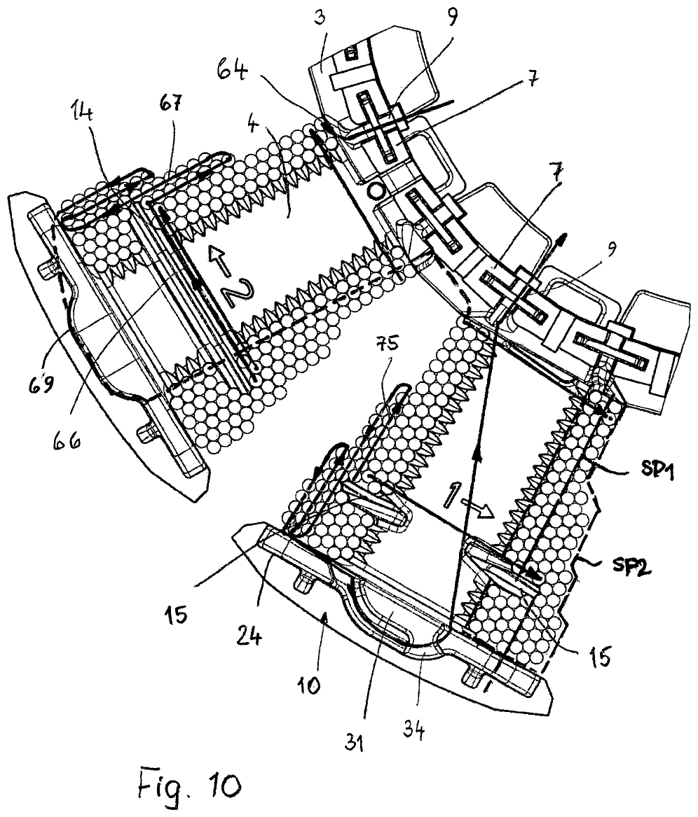

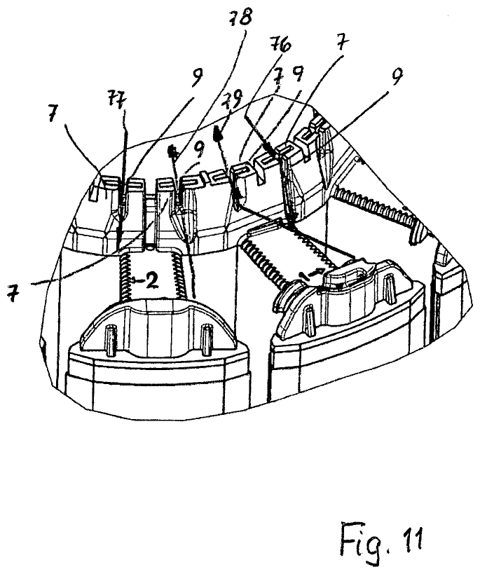

FIGS. 10 and 11 show the winding process of the coil SP2 on the switching side of the teeth 1, 2.

The winding process of the tooth 2 has been explained using FIG. 8. The wire 43 is fed through the transverse slot 9 of the receiving pocket 7 from radially inside. The starting point 64 of the first layer WL1a of the second coil SP2 is located directly adjacent to the receiving pocket 7. The first layer WL1a is wound up to the continuous web 14 in the described manner. At the web 14, the wire is wound back (track 67) in the longitudinal direction of the arm 4 to form the second layer WL2a of the second coil SP2. Subsequently, the further layers WL3a to WL7a of the second coil SP2 are created by repeated winding back and forth, as has been explained using FIG. 8. These further layers of the second coil SP2, as is shown by way of example, can have different lengths in the radial direction, depending on the design of the stator, but for example can also be identical in length.

The layers WL2a to WL7a of the second coil SP2 can also have the same length as the first layer WL1a of the second coil SP2. The length of the individual layers of the second coil SP2 can thus be selected depending on the requirements.

The winding wire 43 is then guided along the track 69 in the described manner to the tooth 1. This transition takes place on the underside of the tooth 2. The second coil SP2 is wound on the tooth 1 analogous to the approach for tooth 2.

The second coil SP2 having the different layers WL1a to WL7a is created on the tooth 1 in the described manner. The first layer WL1a of the second coil SP2 extends between the inner ring 3 and the webs 15. The further layers WL2a to WL7a of the coil SP2 are created by the meandering back and forth movement of the winding needle along the track 75.

Once the further layers WL2a to WL7a of the second coil SP2 have been wound, the wire is deflected at the rear side 24 of the linking body 10 facing away from the receiving pocket 7 and is guided radially inwards through the transverse slot 9 of the corresponding receiving pocket 7. As is explained in relation to the tooth 2 using FIG. 9, the winding wire 43 is guided along the deflecting element 31 and below the lug 34.

The starts and ends of the two coils SP1, SP2 on the teeth 1 and 2 are explained using FIG. 11. The two coils SP1, SP2 are drawn for the tooth 1 in the right half of FIG. 10. The tooth 2 has the same formation of the coils. To form the first coil SP1 on the tooth 1, the winding wire 43 is guided radially from the inside through the transverse slot 9 of the receiving pocket 7 (start 76).

The winding wire is marked with start 77 and is guided radially from the inside through the transverse slot 9 of the associated receiving pocket 7, in order to wind the second coil SP2 on the tooth 2.

78 marks the end of the first coil SP1 on the tooth 2. In this case, the winding wire is guided radially from the outside radially inwards through the transverse slot 9 of the adjacent receiving pocket 7.

79 marks the end of the second coil SP2 on the tooth 1. Also in this case, the winding wire 43 is guided radially from the outside radially inwards through the transverse slot 9 of the associated receiving pocket 7.

The coils or the individual turns are not represented in FIG. 11 for the sake of clarity.

In order to position the start and the end of the first coil SP1 of the tooth 1 on the inner diameter in the region of the receiving pocket 7, the combination of the wire diameter and the number of turns has to precisely match to the available winding space 54, 55. However, since these conditions are not always present, the webs 14, 15 are placed such that the end 44 of the first coil SP1 (FIG. 5) is in the inner diameter region and a simple transition to the tooth 2 (arrow 58 in FIG. 5) is possible.

The number of layers of the first coil SP1 in the radially inner winding space 54 should ideally be an even number. In the exemplary embodiment, the first coil SP1 has two layers WL1, WL2 in the winding space 54.

The number of layers in the radially outer winding space 55 should ideally be a multiple of the layers WL1 to WL4 in the radially inner winding space 54. In the exemplary embodiment shown, four layers WL1 to WL4 of the first coil SP1 are located in the radially outer winding space 55.

The angle at which the winding wire 43 runs through the passage 18 between the webs 15 (FIGS. 5 and 7) is to be as small as possible, so that the winding wire 43 to be laid does not collide with the linking body 10 or the tooth 1, 2 in the region of the groove slot. In FIG. 8, this angle is labelled α. This relates to the end face 23 of the linking body 10 running perpendicular to the longitudinal direction of the arm 4.

A collision can also be prevented because the webs 14,15 are arranged further radially inside along the arm 4, so that the width of the one winding space is greater and the width of the other winding space is smaller.

The thickness 79 (FIG. 8) of the web 15 at the web base should be an integer multiple of the diameter of the winding wire. In this case, an orthocyclic winding of the second coil SP2 is possible, which is wound over the web 15 and the first coil SP1.

By dividing the winding space 54, 55 by the at least one web 14, 15, it is possible, as described, that the transition of the winding wire 43 from tooth 1 to tooth 2 is in the radially inner region of the insulating washers 12, 13. The webs 14, 15 can be seated on the end face and/or laterally protruding on the end insulation elements of the individual teeth 1 to 12. The end insulation elements can be formed by the insulating washers 12, 13 or also by overmoulding of the stator stack 1.

With overmoulding, the webs 14, 15 can also be provided on the lateral walls of the overmoulded arms 4.

The winding wire 43 can be guided in the radial or diagonal direction from the one winding space into the other winding space through the passage 18 between the two webs 14. The winding wire 43 can, as described above, be guided from the winding space 54 into the winding space 55 or vice versa. The webs 15 delimiting the passage 18 are provided with guides in the form of the guide surfaces 59, 60, on which the winding wires 43 can be supported. For the orthocyclic winding, the wire guides 59, 60 run at the angle α (FIG. 8) diagonal to the longitudinal axis of the arm 4 of the teeth 1 to 12.

Since more space is available in the radially outer winding space 55 in the circumferential direction of the stator stack 1 than in the radially inner winding space 54, the radially outer winding space 55 can primarily be filled. Therefore, the smaller space in the radially inner winding space 54 can be used for the start of the wire and the end of the wire or for the transition of the winding wire 43 to the next tooth. The filling capacity of the radially inner winding space 54 is limited in particular by the winding needle, which has to be moved between adjacent teeth during the winding process. The width of the intermediate space 71 measured in the circumferential direction decreases steadily radially inwards.

The described stator is provided for an external rotor motor, in which the rotor surrounds the stator. The start of the wire and the end of the wire of the winding wire 43 for making contact are in the radially inner region of the electrical insulation. In the exemplary embodiment described, adjacent teeth 1, 2 are wound contiguously by one single winding wire 43. In the exemplary embodiment, two coils SP1, SP2 are wound with the winding wire 43, in order to enable a parallel connection of the coils, for example. The two coils are wound onto each other. The described design results in a flawless winding process of the teeth 1 to 12 of the stator.

The stator can be simply and reliably wound for use in an external rotor motor due to the described design of the stator stack 1 having the webs 14, 15. The start of the winding takes place in the radially inner region of the respective insulating washer 12, 13, e.g. in one of the receiving pockets 7. The tooth is then wound radially from the inside radially outwards in the region of the first winding space 54 up to the separating web 14, 15. Then, the winding wire 43 is guided through the passage 18 between the webs 15 from the first winding space 54 into the second winding space 55. The tooth is now wound radially from the inside radially outwards in the region of the second winding space 55 up to the linking body 10, which delimits the winding space 55 radially outwards and is provided on the radially outer end of the arms 4 of the teeth.

The winding wire 43 is subsequently guided radially from the outside radially inwards inside the second winding space 55. The back-and-forth winding of the tooth is carried out until the radially outer winding space 55 is completely wound.

Subsequently, the winding wire 43 is guided back through the passage 18 from the second winding space 55 into the first winding space 54. Then, the winding process of the tooth takes place inside the radially inner winding space 54 radially from the outside radially inwards. The winding wire 43 is then guided radially inwards, so that it can be contacted, e.g. in the respective receiving pocket 7 with the aid of an insulation displacement contact.

In the described exemplary embodiment, the wire is however not led out for contacting radially inwards, but continued to the next tooth, in order to perform the winding process of this next tooth in the radially inner winding space 54. The further tooth is then wound according to the same sequence as the preceding tooth.

It is also possible to wind the second coil SP2 over the first coil SP1 and also over the webs 14, 15 if the webs 14, 15 are designed such that they finish flush with the first coil SP1, as is shown in the drawings by way of example.

1-16. (canceled)

17. A stator for an electric motor or a generator, comprising:
a ring region (3); and
teeth (1 to 12) protruding from the ring region (3),
wherein each of the teeth has
an arm (4) that extends from the ring region (3) and
a web (5) running transversely to the arm at a free end thereof,
wherein each arm (4) supports at least one winding,
wherein each at least one winding includes at least one coil (SP1, SP2) wound by a winding wire (43),
wherein each at least one winding is accommodated in a winding space (54, 55) which extends from the ring region (3), and
wherein each winding space (54, 55) is divided by at least one separating web (14, 15) into successive winding space sections (54, 55), the successive winding space sections (54, 55) being arranged on the arm (4).

18. The stator according to claim 17,
wherein each at least one separating web includes separating webs (14, 15) provided on an upper side and an underside of the teeth (1 to 12) of the stator.

19. The stator according to claim 17,
wherein each at least one separating web (14, 15) is arranged in such a way that the successive winding space sections (54, 55) are of different lengths.

20. The stator according to claim 17,
wherein the at least one separating web (15) of at least some of the teeth (1 to 12) has a passage (18) for the winding wire (43) on an upper side and/or an underside.

21. The stator according to claim 20,
wherein the at least one separating web (15) having the passage (18) has lateral guides (59, 60) for the winding wire (43).

22. The stator according to claim 21,
wherein the guides (59, 60) run at an angle diagonal to a longitudinal direction of the teeth (1 to 12).

23. The stator according to claim 17,
wherein each at least one separating web (14, 15) is positioned on the teeth (1 to 12) in such a way that an end of the coil lies on the ring region (3).

24. The stator according to claim 17,
wherein a radially inner winding space section (54) of the successive winding space sections (54, 55) has such a width in a circumferential direction of the stator that a number of layers (WL1, WL2) of the at least one coil (SP1) is even.

25. The stator according to claim 24,
wherein a radially outer winding space section (55) of the successive winding space sections (54, 55) has such a width in a circumferential direction of the stator that a number of layers (WL1 to WL4) of the at least one coil (SP1) is a multiple of the number of layers in the radially inner winding space section (54).

26. The stator according to claim 20,
wherein a thickness of the at least one separating web (15) having the passage (18), measured at a base of the separating web (15), is an integer multiple of a diameter of the winding wire (43).

27. The stator according to claim 17,
wherein at least one linking body (10) for deflecting the winding wire (43) is provided on the free end of the arms (4) of the teeth (1 to 12).

28. The stator according to claim 27,
wherein the linking body (10) delimits a radially outer winding section (55) of the successive winding space sections (54, 55).

29. The stator according to claim 27,
wherein the linking body (10) and/or a deflecting body (37) is provided with at least one axial securing element (34) for the winding wire (43).

30. The stator according to claim 29,
wherein the axial securing element (34) protrudes laterally from the linking body (10) and/or from the deflecting body (37).

31. The stator according to claim 17,
wherein the separating web (14, 15) is a part of an insulation element (12, 13) lying on end faces of the teeth (1 to 12).

32. The stator according to claim 31,
wherein the insulation element (12, 13) is an insulating washer.

33. The stator according to claim 17,
wherein the motor or a generator is an external rotor motor.
